(19) United States
(12) Patent Application Publication
(10) Pub. No.: US 2009/0319675 A1
(43) Pub. Date: Dec. 24, 2009

(54) METHOD FOR ESTABLISHING FILE SHARING SESSIONS

(76) Inventors: Joerg Ottensmeyer, Hohenkirchen (DE); Thomas Sommer, Wien (AT)

Correspondence Address: LERNER GREENBERG STEMER LLP, P O BOX 2480, HOLLYWOOD, FL, 33022-2480, US

(21) Appl. No.: 12/374,577

(22) PCT Filed: Jul. 23, 2007
(86) PCT No.: PCT/EP07/57579

§ 371 Date: May 22, 2009

(30) Foreign Application Priority Data
Jul. 21, 2006 (DE) 10 2006 033 877.4

(51) Int. Cl. G06F 15/16

(52) U.S. Cl. 709/228; 709/230

(57) ABSTRACT

The session initiation protocol (SIP) is used to establish calls/sessions between end-points. The type of session to be established is described by the session description protocol (SDP), RFC 2327. At present however, RFC 2327 only contains parameters that describe audio or video sessions. The expansion according to the invention of the SDP by corresponding parameters that describe file sharing sessions thus permits file sharing sessions to be established using the SIP.

1. Problem on which the Invention is Based
The Session Initiation Protocol (SIP), RFC 3261, is used for establishing calls/sessions between two end points. The type of session to be established is described by the Session Description Protocol (SDP), RFC 2327. At present, however, RFC 2327 only contains parameters for describing audio or video sessions.

### 2. Previous Solution to the Problem

There are proprietary protocols/products relating to file sharing (e.g. Napster, http://www.napster.com/) by means of which dedicated file sharing sessions can be established between users. However, these cannot be combined with the user management of SIP-based convergent networks.

### 3. Inventive Solution to the Problem

According to the invention, the Session Description Protocol (SDP) is also used for describing file sharing sessions as part of SIP, as a result of which file sharing sessions can also be implemented with the aid of SIP.
According to an exemplary embodiment of the invention, the Session Description Protocol (SDP), RFC 2327, can be extended as follows in order to introduce and to describe file sharing sessions:
a corresponding value for the specification in the parameter m media description (e.g. m=f share)
the specification of the file sharing protocol (e.g. ftp, sftp, nfs) via which file lists can be exchanged and files can then be transported.
(optionally) specifications relating to authentication (algorithm, hashes etc.). The authentication of the file sharing partners involved is as a rule a component of the file sharing protocol (e.g. user name/password in the case of ftp) and does not therefore have to be supplemented in every case in the SDP.
(optionally) specification of the port number of the file sharing server which provides file lists and files if not the well known port (e.g. port 21 for the ftp control connection) are used
(optionally) the specification of the port number of the file sharing client who would like to download the file lists and files from the file sharing server and/or upload files to the file sharing server,

the locator for the resources which can be reached by file sharing protocol (e.g. directory/computer)

(optionally) a mode for the release: read only, read-write, allow update

### 4. Advantages of the Inventive Solution

By using the invention, an operator can use, for example, his existing infrastructure of an IMS/FMC network for switching file sharing sessions for his customers in a comfortable manner.

1. A method for establishing sessions according to Session Initiation Protocol (SIP), wherein
the type of session to be established is described by the Session Description Protocol (SDP),
the SDP is used for describing file sharing sessions,
the parameter m in the media description of the SDP is extended by a value by means of which a file sharing session is described,
the SDP is extended by a parameter which describes the type of file sharing protocol (e.g. ftp, sftp, nfs) via which file lists are exchanged and files are then transported
the SDP is extended by a parameter which provides a reference to the file lists or files characterized in that
the SDP is extended by a parameter for describing the mode of release.

2. The method as claimed in claim 1, characterized in that
it is combined with a user management and a service control of a telecommunication network (e.g. of a next generation network, NGN).

3. A communication network suitable for carrying out the method as claimed in claim 1.
